(19) United States
(12) Patent Application Publication
(10) Pub. No.: US 2008/0162559 A1
(43) Pub. Date: Jul. 3, 2008

(54) ASYNCHRONOUS COMMUNICATIONS REGARDING THE SUBJECT MATTER OF A MEDIA FILE STORED ON A HANDHELD RECORDING DEVICE

(76) Inventors: William K. Bodin, Austin, TX (US); David Jaramillo, Lake Worth, FL (US); Jesse W. Redman, Cedar Park, TX (US); Derral C. Thorson, Austin, TX (US)

Correspondence Address: INTERNATIONAL CORP (BLF), c/o BIGGERS & OHANIAN, LLP, P.O. BOX 1469, AUSTIN, TX, 78767-1469, US

(21) Appl. No.: 11/619,226

(22) Filed: Jan. 3, 2007

(51) Int. Cl. G06F 17/00

(52) U.S. Cl. 707/104.1

(57) ABSTRACT

Methods, systems, and computer program products are provided for asynchronous communications regarding the subject matter of a media file stored on a handheld recording device. Embodiments include interrupting, at an interruption playback time, playback of the media file; receiving from a user, speech regarding the subject matter of the media file; recording the speech in a second media file on the handheld recording device; associating the second media file with the subject matter of the interrupted media file; storing the second media file for transmission; and resuming playback of the interrupted media file at the interruption playback time.

### BACKGROUND OF THE INVENTION

1. Field of the Invention

The field of the invention is data processing, or, more specifically, methods, systems, and products for asynchronous communications regarding the subject matter of a media file stored on a handheld recording device.

2. Description of Related Art

Managers are increasingly isolated from one another and their employees. One reason for this isolation is that managers are often time constrained and their communication occurs with many different devices and often communications requires two or more managers or employees to be available at the same time. Furthermore, often employers elicit information from their employees. Such information is desired but the timing of the receipt of the information is flexible. There is therefore a need for improvement in communications among users such as managers and employees that reduces the devices used to communicate and reduces the requirement for more than one user to communicate at the same time. There is also an ongoing need for improvement in the receipt of information from users.

### SUMMARY OF THE INVENTION

Methods, systems, and computer program products are provided for asynchronous communications regarding the subject matter of a media file stored on a handheld recording device. Embodiments include interrupting, at an interruption playback time, playback of the media file; receiving from a user, speech regarding the subject matter of the media file; recording the speech in a second media file on the handheld recording device; associating the second media file with the subject matter of the interrupted media file; storing the second media file for transmission; and resuming playback of the interrupted media file at the interruption playback time.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram of a system for asynchronous communications using messages recorded on handheld recording devices according to embodiments of the present invention.

FIG. 2 sets forth a block diagram of automated computing machinery comprising an exemplary library management system useful in asynchronous communications according to embodiments of the present invention.

FIG. 3 sets forth a flow chart illustrating an exemplary method for asynchronous communications according to embodiments of the present invention.

FIG. 4 sets forth a flow chart illustrating an exemplary method for associating the message with content under management by a library management system in dependence upon the text converted from a recorded message.

FIG. 5 sets forth a flow chart illustrating another method for associating the message with content under management by a library management system in dependence upon the text converted from a recorded message.

FIG. 6 sets forth a flow chart illustrating another method for associating the message with content under management by a library management system in dependence upon the text converted from a recorded message.

FIG. 7 sets forth a flow chart illustrating an exemplary method for asynchronous communications regarding subject matter of a media file stored on a handheld recording device.

FIG. 8 sets forth a flow chart illustrating further aspects of some embodiments of asynchronous communications regarding subject matter of a media file stored on a handheld recording device according to the present invention.

FIG. 9 sets forth a flow chart illustrating an exemplary method for identifying in a library management system a recipient of the second media file.

FIG. 10 sets forth a block diagram of automated computing machinery comprising an exemplary handheld recording device useful in embodiments according to embodiments of the present invention.

### DETAILED DESCRIPTION OF EXEMPLARY EMBODIMENTS

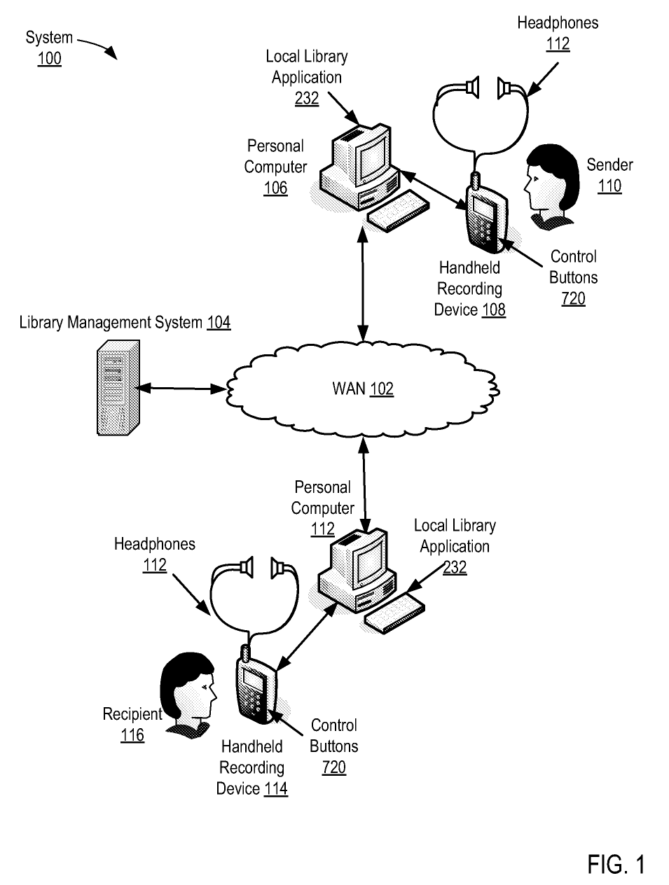

Exemplary methods, systems, and products for asynchronous communications and asynchronous receipt of information in accordance with the present invention are described with reference to the accompanying drawings, beginning with FIG. 1. FIG. 1 sets forth a network diagram of a system 100 for asynchronous communications using messages recorded on handheld recording devices according to embodiments of the present invention. Asynchronous communications means communications among parties that occurs with some time delay. Asynchronous communications according to the present invention may allow participants of communications to send, receive, and respond to communications at their own convenience with no requirement to be available simultaneously.

The exemplary system 100 of FIG. 1 is also capable of asynchronous communications regarding subject matter of a media file stored on a handheld recording device according to the present invention. Asynchronous receipt of information from a user according to embodiments of the present invention includes interrupting at an interruption playback time a playback of a media file stored on a handheld recording device; receiving from a user, speech regarding the subject matter of the media file; recording the speech in a second media file on the handheld recording device; associating the second media file with the subject matter of the interrupted media file; storing the second media file for transmission; and resuming the playback of the interrupted media file at the interruption playback time.

The system 100 of FIG. 1 includes to personal computers (106 and 112) coupled for data communications to a wide area network (‘WAN’) (102). Each of the personal computers (106 and 112) of FIG. 1 have installed upon them a local library application (232). A local library application (232) includes computer program instructions capable of transferring media files containing recorded messages to a handheld recording device (108 and 114). The local library application (232) also includes computer program instructions capable of receiving media files containing messages from the handheld recording device (108 and 114) and transmitting the media files to a library management system (104).

The example of FIG. 1 also includes a library management system (104). The library management system of FIG. 1 is capable of asynchronous communications by receiving a recorded message having been recorded on a handheld recording device (108) converting the recorded message to text; identifying a recipient (116) of the message in dependence upon the text; associating the message with content under management by a library management system in dependence upon the text; and storing the message for transmission to another handheld recording device (114) for the recipient. The exemplary library management system (104) of FIG. 1 manages asynchronous communications using recorded messages according to the present invention, as well as additional content associated with those recorded messages. Such associated content under management include, for example, other recorded messages created by senders and recipients, emails, media files containing media content, spreadsheets, presentations, RSS (‘Really Simple Syndication’) feeds, web pages, and well as any other content that will occur to those of skill in the art. Maintaining the content as well as managing asynchronous communications relating to that content may provide tight coupling between the communications between users and the content related to those communications. Such tight coupling provides the ability to determine that content under management is the subject of the communications and therefore provide an identification of such content to a recipient. Such tight coupling also provides the ability to attach that content to the message providing together the content which is the subject of the communications and the communications themselves.

The handheld recording device (108) or the handheld recording device (114) of FIG. 1 is also capable of asynchronous communications regarding subject matter of a media file stored on the handheld recording device according to the present invention by interrupting at an interruption playback time a playback of a media file stored on the handheld recording device; receiving from a user, speech regarding the subject matter of the media file; recording the speech in a second media file on the handheld recording device; associating the second media file with the subject matter of the interrupted media file; storing the second media file for transmission; and resuming the playback of the interrupted media file at the interruption playback time. In the example of FIG. 1, either the sender (110) or the recipient (116) may be the users for asynchronous receipt of information according to the present invention. Similarly, either the handheld recording device 108 or the handheld recording device (114) may be the handheld recording device storing the media file.

The library management system (104) of FIG. 1 is also capable of asynchronous communications regarding subject matter of a media file stored on a handheld recording device such as the handheld recording device 114 according to the present invention by receiving a second media file from the handheld recording device; converting a recorded speech contained in the second media file to text; identifying in dependence upon the text a recipient of the second media file; and transmitting the second media file to a handheld recording device for the recipient.

The exemplary system 100 of FIG. 1 is capable of asynchronous communications according to the present invention by recording a message from a sender (110) on handheld recording device (108). The handheld recording device includes control buttons (720) for controlling the operation of the device. For example, a control button may activate a microphone for receiving speech of the message and another button may activate recording the message in a media file. One handheld recording device useful according to embodiments of the present invention is the WP-U2J available from Samsung.

The exemplary system 100 of FIG. 1 is capable of transferring the media file containing the recorded message from the handheld recording device (108) to a local library application (232). Media files containing one or messages may be transferred to the local library application by periodically synchronizing the handheld recording device with the local library application allowing a sender to begin transmission of the message at the convenience of the sender.

The exemplary system 100 of FIG. 1 is also capable of transferring the media file containing the recorded message to a library management system (104). The library management system comprises computer program instructions capable of receiving a recorded message; converting the recorded message to text; identifying a recipient of the message in dependence upon the text; associating the message with content under management by a library management system in dependence upon the text; and storing the message for transmission to another handheld recording device for the recipient.

The exemplary system 100 of FIG. 1 is also capable of transferring the media file containing the recorded message to a local library application (232) installed on a personal computer (112). The system 100 of FIG. 1 is also capable of transmitting message to the handheld recording device (114) of the recipient (116) who may listen to the message using headphones (112) or speakers on the device. A recipient may transfer messages to the handheld recording device by synchronizing the handheld recording device with the local library application (232) allowing the recipient to obtain messages at the recipients convenience. The recipient may now respond to the message received by sending a reply message to the sender in the same manner providing two way asynchronous communications between sender and recipient. That is, the recipient may record a response or reply message in a media file, associate the media file with the subject matter of the received message, and store the recorded reply message for transmission to the sender or another user.

The arrangement of devices making up the exemplary system 100 illustrated in FIG. 1 is for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld recording device Transport Protocol), and others as will occur to those of skill in the art. Various embodiments of the present invention may be implemented on a variety of hardware platforms in addition to those illustrated in FIG. 1.

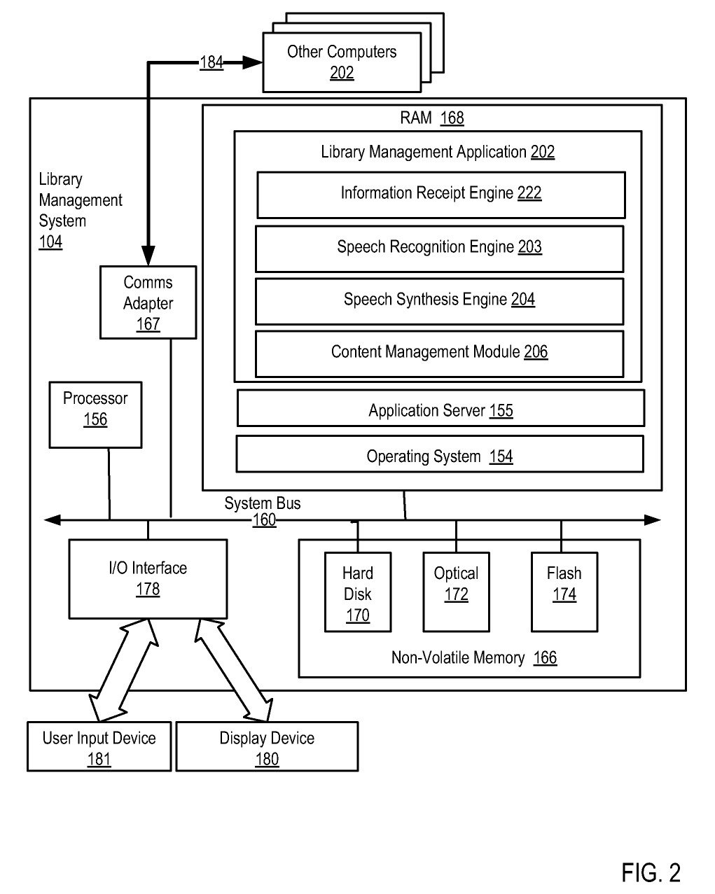

Asynchronous communications and asynchronous communications regarding subject matter of a media file stored on a handheld recording device in accordance with the present invention is generally implemented with computers, that is, with automated computing machinery. In the system 100 of FIG. 1, for example, all the nodes, servers, and communications devices are implemented to some extent at least as computers. For further explanation, therefore, FIG. 2 sets forth a block diagram of automated computing machinery comprising an exemplary library management system (104) useful in asynchronous communications according to embodiments of the present invention. The library management system (104) of FIG. 2 includes at least one computer processor (156) or ‘CPU’ as well as random access memory (168) (‘RAM’) which is connected through a system bus (160) to processor (156) and to other components of the library management system.

Stored in RAM (168) is a library management application (202) for asynchronous communications according to the present invention including computer program instructions for receiving a recorded message, the message recorded on a handheld recording device; converting the recorded message to text; identifying a recipient of the message in dependence upon the text; associating the message with content under management by a library management system in dependence upon the text; and storing the message for transmission to another handheld recording device for the recipient.

The library management application (202) also includes an information receipt engine (222) capable of asynchronous communications regarding subject matter of a media file stored on a handheld recording device according to the present invention. The library management application (202) includes computer program instructions for receiving a second media file from a handheld recording device; converting a recorded speech contained in the second media file to text; identifying in dependence upon the text a recipient of the second media file; and transmitting the second media file to a handheld recording device for the recipient.

The library management application (202) of FIG. 2 also includes a speech recognition engine (203), computer program instructions for converting a recorded speech or message to text. Examples of speech recognition engines capable of modification for use with library management applications according to the present invention include SpeechWorks available from Nuance Communications, Dragon NaturallySpeaking also available from Nuance Communications, ViaVoice available from IBM®, Speech Magic available from Philips Speech Recognition Systems, iListen from MacSpeech, Inc., and others as will occur to those of skill in the art.

The library management application (202) of FIG. 2 includes a speech synthesis engine (204), computer program instructions for creating speech identifying the content associated with the message. Examples of speech engines capable of creating speech identifying the content associated with the message, for example, IBM's ViaVoice Text-to-Speech, Acapela Multimedia TTS, AT&T Natural Voices™ Text-to-Speech Engine, and Python's pyTTS class.

The library management application (202) of FIG. 2 includes a content management module (206), computer program instructions for receiving a recorded message; identifying a recipient of the message in dependence upon text converted from the message; associating the message with content under management by a library management system in dependence upon the text; and storing the message for transmission to another handheld recording device for the recipient.

Also stored in RAM (168) is an application server (155), a software platform that provides services and infrastructure required to develop and deploy business logic necessary to provide web clients with access to enterprise information systems. Also stored in RAM (168) is an operating system (154). Operating systems useful in computers according to embodiments of the present invention include UNIX™, Linux™, Microsoft XP™, AIX™, IBM's i5/OS™, and others as will occur to those of skill in the art. Operating system (154) and library management module (202) in the example of FIG. 2 are shown in RAM (168), but many components of such software typically are stored in non-volatile memory (166) also.

Library management system (104) of FIG. 2 includes non-volatile computer memory (166) coupled through a system bus (160) to processor (156) and to other components of the library management system (104). Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The exemplary library management system of FIG. 2 includes one or more input/output interface adapters (178). Input/output interface adapters in library management systems implement user-oriented input/output through, for example, software drivers and computer hardware for controlling output to display devices (180) such as computer display screens, as well as user input from user input devices (181) such as keyboards and mice.

The exemplary library management system (104) of FIG. 2 includes a communications adapter (167) for implementing data communications (184) with other computers (202). Such data communications may be carried out serially through RS-232 connections, through external buses such as USB, through data communications networks such as IP networks, and in other ways as will occur to those of skill in the art. Communications adapters implement the hardware level of data communications through which one computer sends data communications to another computer, directly or through a network. Examples of communications adapters useful for asynchronous communications according to embodiments of the present invention include modems for wired dial-up communications, Ethernet (IEEE 802.3) adapters for wired network communications, and 802.11b adapters for wireless network communications.

### Asynchronous Communications

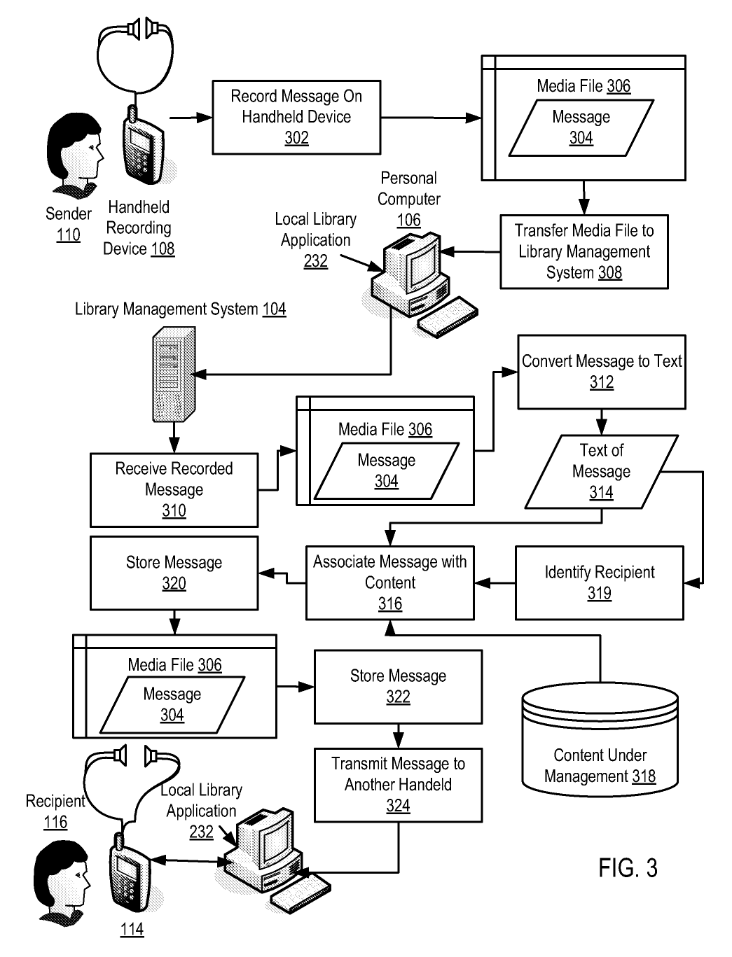

For further explanation, FIG. 3 sets forth a flow chart illustrating an exemplary method for asynchronous communications according to embodiments of the present invention that includes recording (302) a message (304) on handheld recording device (108). Recording (302) a message (304) on handheld recording device (108) typically includes recording a speech message on a handheld recording device (108) in a media file (306) using a data format supported by the handheld recording device (108). Examples of media files useful in asynchronous communications according to the present invention include MPEG 3 (‘.mp3’) files, MPEG 4 (‘.mp4’) files, Advanced Audio Coding (‘AAC’) compressed files, Advances Streaming Format (‘ASF’) Files, WAV files, and many others as will occur to those of skill in the art.

The method of FIG. 3 includes transferring (308) a media file (306) containing the recorded message (304) to a library management system (104). As discussed above, one way of transferring (308) a media file (306) containing the recorded message (304) to a library management system (104) includes synchronizing the handheld recording device (108) with a local library application (232) which in turns uploads the media file to the local management system. Synchronizing the handheld recording device (108) with a local library application (232) may allow a sender to record messages at the sender's convenience and also the sender to initiate the sending of those messages at the sender's convenience.

The method of FIG. 3 also includes receiving (310) the recorded message (304). In the example of FIG. 3, a library management system (104) receives the recorded message in a media file from a local library application (232). Local library applications (232) according to the present invention may be configured to upload messages from a sender to a library management system (104) and download messages for a recipient from a library management system (104) periodically, such as daily, hourly and so on, upon synchronization with handheld recording devices, or in any other manner as will occur to those of skill in the art.

The method of FIG. 3 also includes converting (312) the recorded message (304) to text (314). Converting (312) the recorded message (304) to text (314) may be carried out by a speech recognition engine (203). Speech recognition is the process of converting a speech signal to a set of words, by means of an algorithm implemented as a computer program. Different types of speech recognition engines currently exist. Isolated-word speech recognition systems, for example, require the speaker to pause briefly between words, whereas continuous speech recognition systems do not. Furthermore, some speech recognition systems require a user to provide samples of his or her own speech before using them, whereas other systems are said to be speaker-independent and do not require a user to provide samples.

To accommodate larger vocabularies, speech recognition engines use language models or artificial grammars to restrict the combination of words and increase accuracy. The simplest language model can be specified as a finite-state network, where the permissible words following each word are explicitly given. More general language models approximating natural language are specified in terms of a context-sensitive grammar.

Examples of commercial speech recognition engines currently available include SpeechWorks available from Nuance Communications, Dragon NaturallySpeaking also available from Nuance Communications, ViaVoice available from IBM®, Speech Magic available from Philips Speech Recognition Systems, iListen from MacSpeech, Inc., and others as will occur to those of skill in the art.

The method of FIG. 3 also includes identifying (319) a recipient (116) of the message (304) in dependence upon the text (314). Identifying (319) a recipient (116) of the message (304) in dependence upon the text (314) may be carried out by scanning the text for previously identified names or user identifications. Upon finding a match, identifying (319) a recipient (116) of the message (304) may be carried out by retrieving a user profile for the identified recipient including information facilitating sending the message to the recipient.

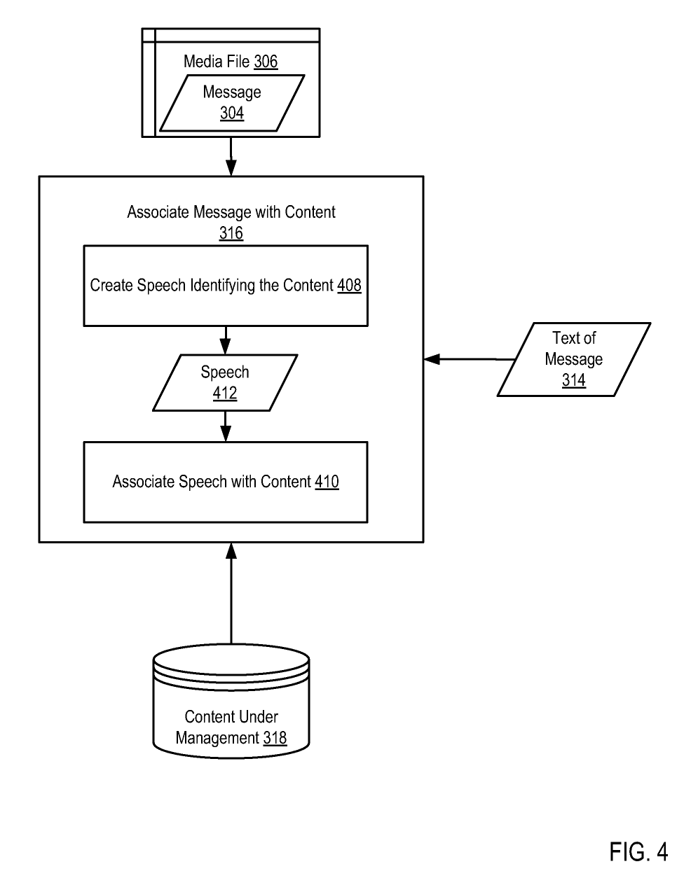

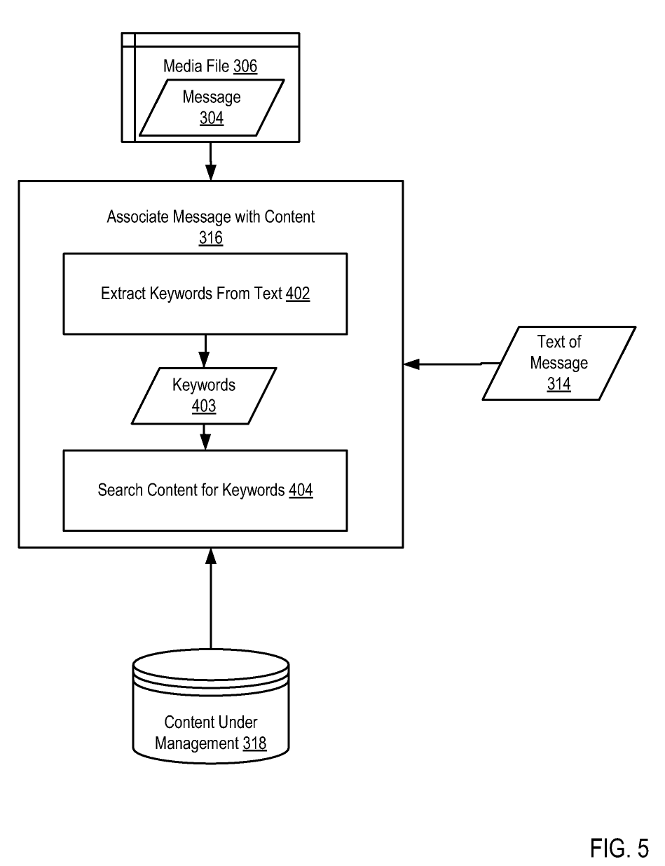

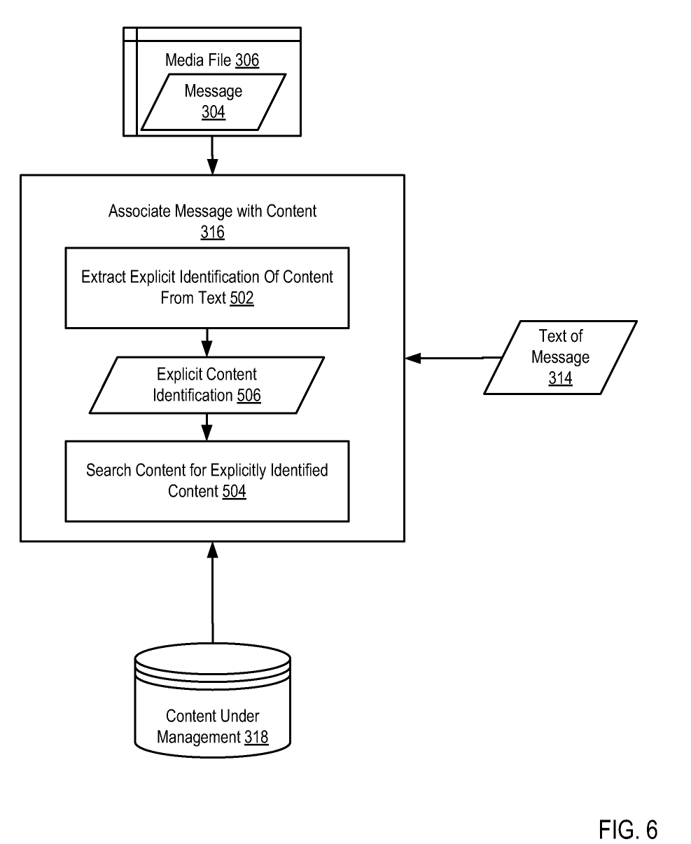

The method of FIG. 3 also includes associating (316) the message (304) with content (318) under management by a library management system in dependence upon the text (314). Associating (316) the message (304) with content (318) under management by a library management system in dependence upon the text (314) may be carried out by creating speech identifying the content associated with the message; and associating the speech with the recorded message for transmission with the recorded message as discussed below with reference to FIG. 4. Associating (316) the message (304) with content (318) under management by a library management system in dependence upon the text (314) may also be carried out by extracting keywords from the text; and searching content under management for the keywords as discussed below with reference to FIG. 5. Associating (316) the message (304) with content (318) under management by a library management system in dependence upon the text (314) may also be carried out by extracting an explicit identification of the associated content from the text; and searching content under management for the identified content as discussed below with reference with FIG. 6.

The method of FIG. 3 also includes storing (320) the message (304) for transmission to another handheld recording device (114) for the recipient (116). In the example of FIG. 3, a library management system (104) stores the message for downloading to local library application (232) for the recipient.

The method of FIG. 3 also includes transmitting (324) the message (304) to another handheld recording device (114). Transmitting (324) the message (304) to another handheld recording device (114) according to the method of FIG. 3 may be carried out by downloading the message to a local library application (232) for the recipient (116) and synchronizing the handheld recording device (114) with the local library application (232). Local library applications (232) according to the present invention may be configured to download messages for a recipient from a library management system (104) periodically, such as daily, hourly and so on, upon synchronization with handheld recording devices, or in any other manner as will occur to those of skill in the art. The recipient (116) may now respond or reply to the message (304) received by sending a reply message to the sender (110) in the same manner providing two way asynchronous communications between the sender (110) and the recipient (116).

To aid users in communication, content identified as associated with communications among users may be identified, described in speech, and presented to those users thereby seamlessly supplementing the existing communications among the users. For further explanation, FIG. 4 sets forth a flow chart illustrating an exemplary method for associating (316) the message (304) with content (318) under management by a library management system in dependence upon the text (314). The method of FIG. 4 includes creating (408) speech (412) identifying the content (318) associated with the message (304). Creating (408) speech (412) identifying the content (318) associated with the message (304) may be carried out by processing the text using a text-to-speech engine in order to produce a speech presentation of the text and then recording the speech produced by the text-speech-engine in the audio portion of a media file. Examples of speech engines capable of converting text to speech for recording in the audio portion of a media file include, for example, IBM's ViaVoice Text-to-Speech, Acapela Multimedia TTS, AT&T Natural Voices™ Text-to-Speech Engine, and Python's pyTTS class. Each of these text-to-speech engines is composed of a front end that takes input in the form of text and outputs a symbolic linguistic representation to a back end that outputs the received symbolic linguistic representation as a speech waveform.

Typically, speech synthesis engines operate by using one or more of the following categories of speech synthesis: articulatory synthesis, formant synthesis, and concatenative synthesis. Articulatory synthesis uses computational biomechanical models of speech production, such as models for the glottis and the moving vocal tract. Typically, an articulatory synthesizer is controlled by simulated representations of muscle actions of the human articulators, such as the tongue, the lips, and the glottis. Computational biomechanical models of speech production solve time-dependent, 3-dimensional differential equations to compute the synthetic speech output. Typically, articulatory synthesis has very high computational requirements, and has lower results in terms of natural-sounding fluent speech than the other two methods discussed below.

Formant synthesis uses a set of rules for controlling a highly simplified source-filter model that assumes that the glottal source is completely independent from a filter which represents the vocal tract. The filter that represents the vocal tract is determined by control parameters such as formant frequencies and bandwidths. Each formant is associated with a particular resonance, or peak in the filter characteristic, of the vocal tract. The glottal source generates either stylized glottal pulses for periodic sounds and generates noise for aspiration. Formant synthesis often generates highly intelligible, but not completely natural sounding speech. However, formant synthesis typically has a low memory footprint and only moderate computational requirements.

Concatenative synthesis uses actual snippets of recorded speech that are cut from recordings and stored in an inventory or voice database, either as waveforms or as encoded speech. These snippets make up the elementary speech segments such as, for example, phones and diphones. Phones are composed of a vowel or a consonant, whereas diphones are composed of phone-to-phone transitions that encompass the second half of one phone plus the first half of the next phone. Some concatenative synthesizers use so-called demi-syllables, in effect applying the diphone method to the time scale of syllables. Concatenative synthesis then strings together, or concatenates, elementary speech segments selected from the voice database, and, after optional decoding, outputs the resulting speech signal. Because concatenative systems use snippets of recorded speech, they often have the highest potential for sounding like natural speech, but concatenative systems typically require large amounts of database storage for the voice database.

The method of FIG. 4 also includes associating (410) the speech (412) with the recorded message (304) for transmission with the recorded message (304). Associating (410) the speech (412) with the recorded message (304) for transmission with the recorded message (304) may be carried out by including the speech in the same media file as the recoded message, creating a new media file containing both the recorded message and the created speech, or any other method of associating the speech with the recorded message as will occur to those of skill in the art.

As discussed above, associated messages with content under management often requires identifying the content. For further explanation, FIG. 5 sets forth a flow chart illustrating another method for associating (316) the message (304) with content (318) under management by a library management system in dependence upon the text (314). The method of FIG. 5 includes extracting (402) keywords (403) from the text (314). Extracting (402) keywords (403) from the text (314) may be carried out by extracting words from the text that elicit information about content associated with the subject matter of the message such as, for example, ‘politics,’ ‘work,’ ‘movies,’ and so. Extracting (402) keywords (403) from the text (314) also may be carried out by extracting words from the text identifying types of content such as, for example, ‘email,’ ‘file,’ ‘presentation,’ and so on. Extracting (402) keywords (403) from the text (314) also may be carried out by extracting words from the text having temporal semantics, such as ‘yesterday,’ ‘Monday,’ ‘10:00 am.’ and so on. The examples of extracting words indicative of subject matter, content type, or temporal semantics are presented for explanation and not for limitation. In fact, associating (316) the message (304) with content (318) under management by a library management system in dependence upon the text (314) may be carried out in many was as will occur to those of skill in the art and all such ways are within the scope of the present invention.

The method of FIG. 5 also includes searching (404) content (318) under management for the keywords (403). Searching (404) content (318) under management for the keywords (403) may be carried out by searching the titles, metadata, and content itself for the keywords and identifying as a match content having the most matching keywords or content having the best matching keywords according to predefined algorithms for selecting matching content from potential matches.

In some cases, the messages comprising communications among users may contain an explicit identification of content under management. For further explanation, FIG. 6 sets forth a flow chart illustrating another method for associating (316) the message (304) with content (318) under management by a library management system in dependence upon the text (314) includes extracting (502) an explicit identification (506) of the associated content from the text and searching content (318) under management for the identified content (506). Extracting (502) an explicit identification (506) of the associated content from the text may be carried out by identifying one or more words in the text matching a title or closely matching a title or metadata identification of specific content under management. For example, the phrase ‘the Jones Presentation,’ may be extracted as an explicit identification of a PowerPoint™ Presentation entitled ‘Jones Presentation 5-2-2006.’ For example, the phrase ‘Your message of Yesterday,’ may be extracted as an explicit identification of a message from the intended recipient of the message send a day earlier than the current message from which the text was converted according to the present invention.

### Asynchronous Communications Regarding the Subject Matter of a Media File Stored on a Handheld Recording Device

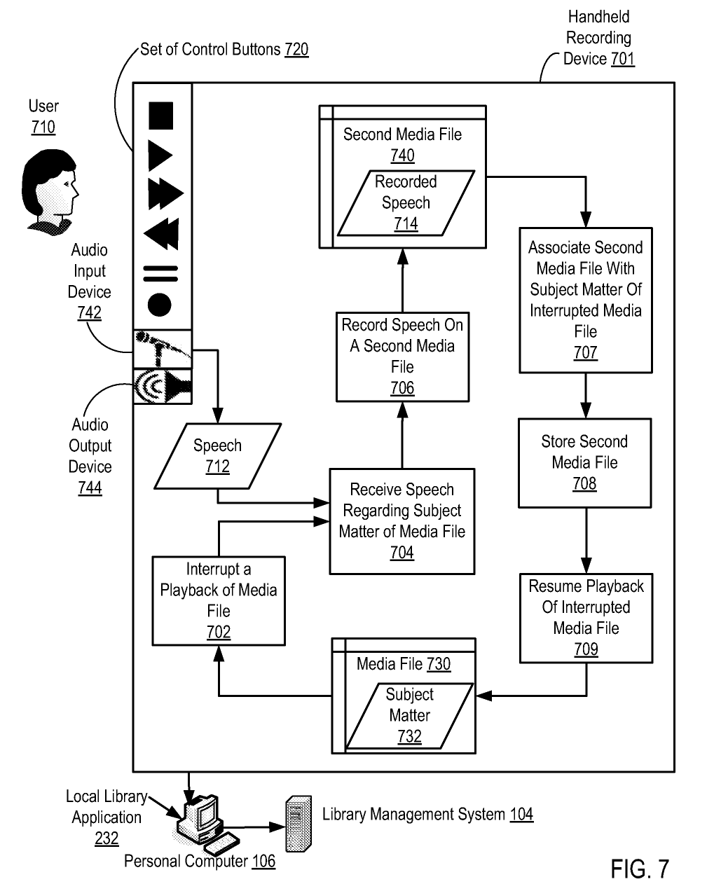

For further explanation, FIG. 7 sets forth a flow chart illustrating an exemplary method for asynchronous communications regarding the subject matter of a media file stored on a handheld recording device. The method of FIG. 7 includes interrupting (702) at an interruption playback time the playback of the media file (730) stored on a handheld recording device (701). An interruption playback time is the playback time in the media file at which the playback of the media file is interrupted. Interrupting (702) at an interruption playback time the playback of the media file (730) stored on a handheld recording device (701) may be carried out by a user invoking one or more controls on the handheld recording device. Some handheld recording devices may support speech activation of controls. For such devices, interrupting (702) at an interruption playback time the playback of the media file (730) stored on a handheld recording device (701) may also be carried out by receiving a speech command to interrupt the playback of the media file.

The method of FIG. 7 includes receiving (704) from the user (710) speech (712) regarding the subject matter (732) of the media file (730). Receiving (704) from the user (710) speech (712) regarding the subject matter (732) of the media file (730) may be carried out by receiving through an audio input device (742) speech. The received speech in the method of FIG. 7 is directed toward the subject matter of the media file. Such speech may be a user's comments on the subject matter of the media file, a user's questions regarding the content of the media file, or any other speech related to the subject matter of the media file as will occur to those of skill in the art.

The method of FIG. 7 also includes recording (706) the speech (712) in a second media file (740) on the handheld recording device (701). As mentioned above, examples of media files useful in asynchronous communications regarding subject matter of a media file stored on a handheld recording device according to the present invention include MPEG 3 (‘.mp3’) files, MPEG 4 (‘.mp4’) files, Advanced Audio Coding (‘AAC’) compressed files, Advances Streaming Format (‘ASF’) Files, WAV files, and many others as will occur to those of skill in the art.

The method of FIG. 7 also includes associating (707) the second media file (740) with the subject matter of the interrupted media file (730). Associating (707) the second media file (740) with the subject matter of the interrupted media file (730) may be carried out by creating a record associating an identification of the interrupted media file and the second media file. Such a record may include, for example, a file name of the interrupted media file and a file name of the second media file. Such a record provides vehicle for linking the speech recorded on the second media file with the interrupted media file.

The method of FIG. 7 also includes storing (708) the second media file (740) for transmission. Storing (708) the second media file (740) for transmission may be carried out by storing the second media file in memory for transmission to a library management system and ultimately, for example, to other users.

The method of FIG. 7 also includes resuming (709) playback of the interrupted media file (730) at the interruption playback time. Resuming (709) playback of the interrupted media file (730) at the interruption playback time continues the playback of the interrupted media file.

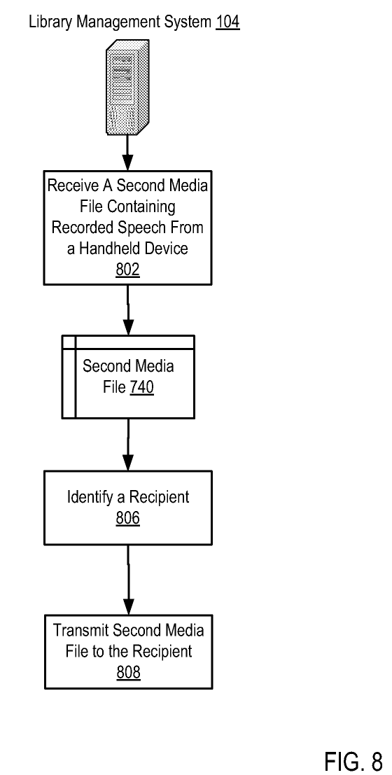

Asynchronous communications regarding subject matter of a media file stored on a handheld recording device according to the present invention often includes recording speech on a second media file intended for another user. For further explanation, therefore, FIG. 8 sets forth a flow chart illustrating further aspects of some embodiments of asynchronous communications regarding subject matter of a media file stored on a handheld recording device according to the present invention. The method of FIG. 8 includes receiving (802) the second media file (740) in a library management system (104). Receiving (802) the second media file (740) in a library management system (104) may be carried out by receiving in the library management system the second media file from a local library application (232) which in turn received the second media file from the handheld recording device. Local library applications according to the present invention may be configured to upload media files periodically, such as daily, hourly and so on, upon synchronization with handheld recording devices, or in any other manner as will occur to those of skill in the art.

The method of FIG. 8 includes identifying (806) a recipient of the second media file (740). Identifying a recipient of the second media file may be carried out by converting the recorded speech to text and identifying, in dependence upon the text, a recipient of the second media file. Identifying, in dependence upon the text, a recipient of the second media file may be carried out by rules designed to parse the text for an identification of the recipient.

Identifying (806) a recipient of the second media file (740) may also include identifying a recipient of the second media file in dependence upon the interrupted media file. Identifying a recipient of the second media file in dependence upon the interrupted media file may include identifying the sender of the interrupted media file as the recipient of the second media file, converting the interrupted media file to text and identifying in dependence upon the text a recipient, or in other ways as will occur to those of skill in the art.

The method of FIG. 8 also includes transmitting (808) the second media file (740) to a handheld recording device for the recipient. Transmitting (808) the second media file (740) to a handheld recording device for the recipient may be carried out by downloading the second media file a local library application for the recipient and synchronizing the handheld recording device with the local library application.

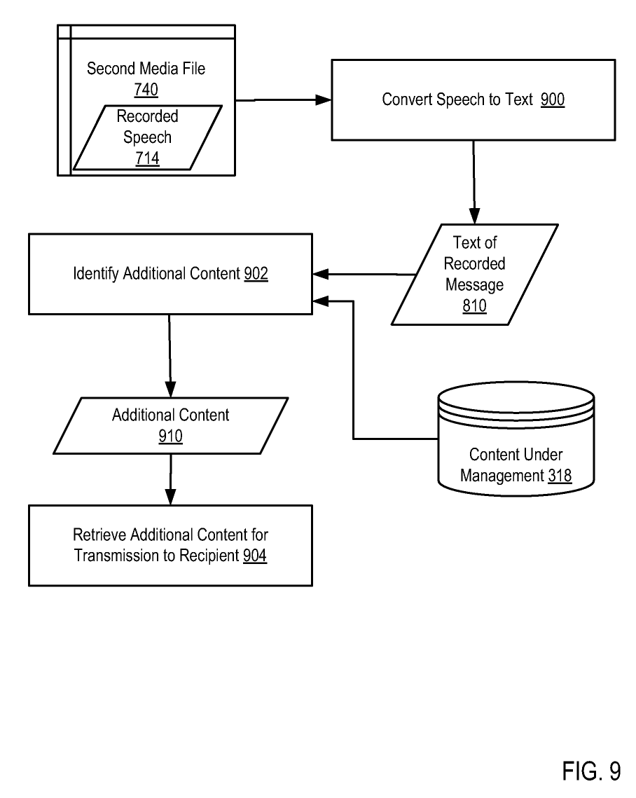

To aid users in communication, additional content that may be identified and presented to recipients thereby seamlessly supplementing the existing communications among the users. For further explanation, therefore, FIG. 9 sets forth a flow chart illustrating an exemplary method for identifying in a library management system a recipient of the second media file. The method of FIG. 9 includes converting (900) the recorded speech to text (810) and identifying (902) in dependence upon the text (810) additional content (910). Identifying (902) in dependence upon the text (810) additional content (910) may be carried out using rules for parsing the text to identify the subject matter of the text and searching a database of content under management (318) for additional content related to the subject matter.

The method of FIG. 9 also includes retrieving (904) the additional content (910) for transmission to the recipient. Retrieving (904) the additional content (910) for transmission to the recipient may be carried out by retrieving the identified additional content from a database of content under management (318).

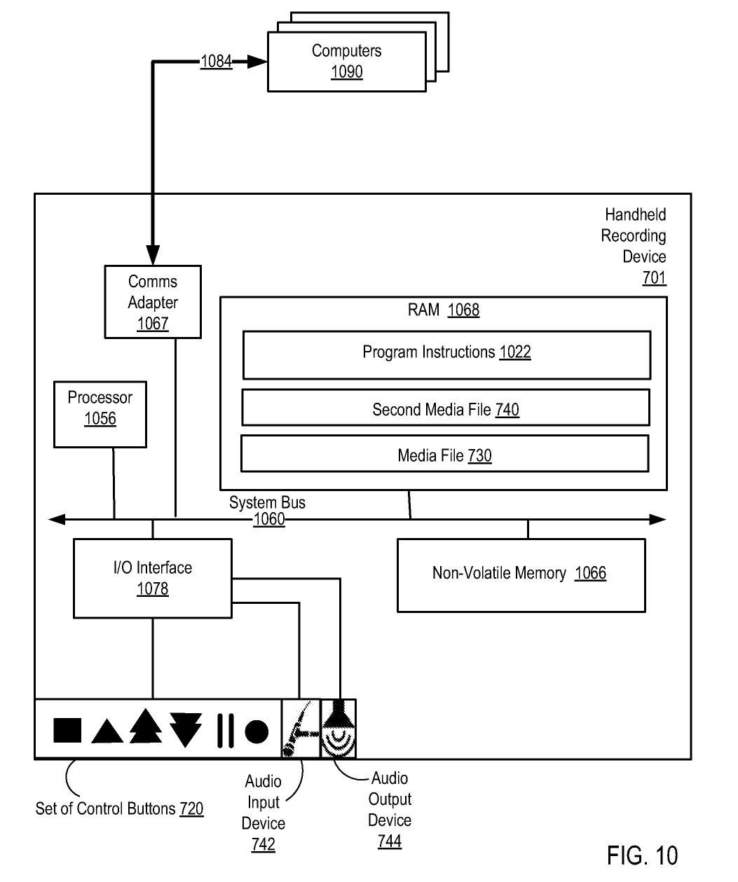

Asynchronous communications regarding subject matter of a media file stored on a handheld recording device in accordance with the present invention is generally implemented with handheld recording devices. For further explanation, therefore, FIG. 10 sets forth a block diagram of automated computing machinery comprising an exemplary handheld recording device useful in asynchronous communications according to embodiments of the present invention. The handheld recording device (701) of FIG. 7 includes at least one computer processor (1056) or ‘CPU’ as well as random access memory (1068) (‘RAM’) which is connected through a system bus (1060) to processor (1056) and to other components such as a non-volatile memory (1066), and an input/output (I/O) interface (1078). The handheld recording device (701) may be implemented using logic circuits such as a field programmable gate array (FPGA), or an application specific integrated circuit (ASIC) instead of or in addition to the processor (1056) as will occur to those of skill in the art.

The RAM (1068) memory stores the media file (730) and the second media file (740). The I/O interface (1078) interfaces to a set of control buttons (720) that are operable to control a mode of operation of the handheld recording device (701). The set of control buttons (720) include a playback, stop, record, pause, rewind, fast forward, and similar other buttons, which are operable to place the handheld recording device (701) in a corresponding mode of operation. The I/O interface (1078) is also coupled to an audio input device (742) capable of receiving audio signals, e.g., from the user (710), and an audio output device (744) capable of providing audio signals, e.g., to the user (710). The audio signals received by the audio input device (742) are also capable of controlling the mode of operation of the handheld recording device (701). Also stored in the RAM (1068) are computer program instructions (1022) for interrupting at an interruption playback time a playback of a media file stored on a handheld recording device; receiving from a user, speech regarding the subject matter of the media file; recording the speech in a second media file on the handheld recording device; associating the second media file with the subject matter of the interrupted media file; storing the second media file for transmission; and resuming the playback of the interrupted media file at the interruption playback time.

The exemplary handheld recording device (701) of FIG. 10 includes a communications adapter (1067) for implementing data communications (1084) with other computers (1090) such as personal computers 106 and 112. Such data communications may be carried out serially through RS-232 connections, through external buses such as USB, through data communications networks such as IP networks, and in other ways as will occur to those of skill in the art. Communications adapters implement the hardware level of data communications through which one computer sends data communications to another computer, directly or through a network. Examples of communications adapters useful for asynchronous communications according to embodiments of the present invention include modems for wired dial-up communications, Ethernet (IEEE 802.3) adapters for wired network communications, and 802.11b adapters for wireless network communications.

Exemplary embodiments of the present invention are described largely in the context of a fully functional computer system for asynchronous communications using messages recorded on handheld recording devices and asynchronous communications regarding the subject matter of a media file stored on a handheld recording device. Readers of skill in the art will recognize, however, that the present invention also may be embodied in a computer program product disposed on computer readable media for use with any suitable data processing system. Such computer readable media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for asynchronous communications regarding the subject matter of a media file stored on a handheld recording device, the method comprising:
interrupting, at an interruption playback time, playback of the media file;
receiving from a user, speech regarding the subject matter of the media file;
recording the speech in a second media file on the handheld recording device;
associating the second media file with the subject matter of the interrupted media file;
storing the second media file for transmission; and
resuming playback of the interrupted media file at the interruption playback time.

2. The method of claim 1 further comprising:
receiving the second media file in a library management system;
identifying a recipient of the second media file; and
transmitting the second media file to a handheld recording device for the recipient.

3. The method of claim 2 wherein identifying a recipient of the second media file further comprises:
converting the recorded speech to text; and
identifying, in dependence upon the text, a recipient of the second media file.

4. The method of claim 2 wherein identifying a recipient of the second media file further comprises identifying a recipient of the second media file in dependence upon the interrupted media file.

5. The method of claim 2 wherein identifying a recipient of the second media file further comprises:
converting the recorded speech to text; and
identifying in dependence upon the text additional content; and
retrieving the additional content for transmission to the recipient.

6. The method of claim 1 wherein associating the second media file with the subject matter of the interrupted media file further comprises associating a file name of the second media file with a file name of the interrupted media file.

7. A system for asynchronous communications regarding the subject matter of a media file stored on a handheld recording device, the system comprising a computer processor, a computer memory operatively coupled to the computer processor, the computer memory having disposed within it computer program instructions capable of:
interrupting, at an interruption playback time, playback of the media file;
receiving from a user, speech regarding the subject matter of the media file;
recording the speech in a second media file on the handheld recording device;
associating the second media file with the subject matter of the interrupted media file;
storing the second media file for transmission; and
resuming playback of the interrupted media file at the interruption playback time.

8. The system of claim 7 wherein the computer memory further comprises computer program instructions capable of:
receiving the second media file in a library management system;
identifying a recipient of the second media file; and
transmitting the second media file to a handheld recording device for the recipient.

9. The system of claim 8 wherein computer program instructions capable of identifying a recipient of the second media file further comprise computer program instructions capable of:
converting the recorded speech to text; and
identifying, in dependence upon the text, a recipient of the second media file.

10. The system of claim 8 wherein computer program instructions capable of identifying a recipient of the second media file further comprise computer program instructions capable of identifying a recipient of the second media file in dependence upon the interrupted media file.

11. The system of claim 8 wherein computer program instructions capable of identifying a recipient of the second media file further comprise computer program instructions capable of:
converting the recorded speech to text; and
identifying in dependence upon the text additional content; and
retrieving the additional content for transmission to the recipient

12. The system of claim 7 wherein computer program instructions capable of associating the second media file with the subject matter of the interrupted media file further comprise computer program instructions capable of associating a file name of the second media file with a file name of the interrupted media file.

13. A computer program product for asynchronous communications regarding the subject matter of a media file stored on a handheld recording device, the computer program product embodied on a computer-readable medium, the computer program product comprising:
computer program instructions for interrupting, at an interruption playback time, playback of the media file;
computer program instructions for receiving from a user, speech regarding the subject matter of the media file;
computer program instructions for recording the speech in a second media file on the handheld recording device;
computer program instructions for associating the second media file with the subject matter of the interrupted media file;
computer program instructions for storing the second media file for transmission; and
computer program instructions for resuming the playback of the interrupted media file at the interruption playback time.

14. The computer program product of claim 13 further comprising:
computer program instructions for receiving the second media file in a library management system;
computer program instructions for identifying a recipient of the second media file; and
computer program instructions for transmitting the second media file to a handheld recording device for the recipient.

15. The computer program product of claim 13 wherein computer program instructions for identifying a recipient of the second media file further comprise:
computer program instructions for converting the recorded speech to text; and
computer program instructions for identifying, in dependence upon the text, a recipient of the second media file.

16. The computer program product of claim 13 wherein computer program instructions for identifying a recipient of the second media file further comprise computer program instructions for identifying a recipient of the second media file in dependence upon the interrupted media file.

17. The computer program product of claim 13 wherein computer program instructions for identifying a recipient of the second media file further comprise:
computer program instructions for converting the recorded speech to text; and
computer program instructions for identifying in dependence upon the text additional content; and
computer program instructions for retrieving the additional content for transmission to the recipient.

18. The computer program product of claim 13 wherein computer program instructions for associating the second media file with the subject matter of the interrupted media file further comprise computer program instructions for associating a file name of the second media file with a file name of the interrupted media file.

19. The computer program product of claim 13 wherein the computer readable medium comprises a recordable medium.

20. The computer program product of claim 13 wherein the computer readable medium comprises a transmission medium.
